(19) United States
(12) Patent Application Publication
(10) Pub. No.: US 2018/0168914 A1
(43) Pub. Date: Jun. 21, 2018

(54) MASSAGE SYSTEM

(71) Applicant: FAMILY INADA CO., LTD., Osaka (JP)

(72) Inventor: Nichimu Inada, Osaka (JP)

(21) Appl. No.: 15/842,325

(22) Filed: Dec. 14, 2017

(30) Foreign Application Priority Data
Dec. 15, 2016 (JP) 2016-243816

(51) Int. Cl. A61H 7/00; A61H 15/00; A61H 23/02; H04L 29/08

(52) U.S. Cl. CPC A61H 7/007; A61H 15/0078; H04L 9/32; H04L 67/12; A61H 2201/0149; A61H 23/02

(57) ABSTRACT

A massage system includes a medium and a massage machine. The medium includes data or an identification code. The massage machine includes a massage unit, a control unit, an input unit that captures data or an identification code of a medium, and an identification unit that identifies the data or the identification code. The control unit specifies a control content, based on an identification result obtained by the identification unit, and controls the massage unit according to the control content. The data may include a bar code or two-dimensional codes.

### RELATED APPLICATION

This application claims the Convention priority based on Japanese Patent Application No. 2016-243816 filed on Dec. 15, 2016, the contents of which, including the specification, the claim and the drawings, are incorporated herein by reference in their entirety.

### TECHNICAL FIELD

The present invention relates to a massage system.

### BACKGROUND ART

In the related art, a drive control device of an electric massage machine is known. In the electric massage machine, a barcode reader for reading a barcode from a barcode display medium having a predetermined use time, and a collation unit collate with the barcode read from the reader and a specific barcode preset in the collation unit. Regardless of collation results, an unnecessary operation of the reader is stopped using a collation completion output. When the collation results coincide with each other, a timer circuit is actuated using a coincidence output, and a power supply relay on the massage machine side connected to an output terminal thereof is turned on for a predetermined period of time. In this manner, an electric massage member can be driven only for the predetermined period of time by the barcode display medium having the predetermined use time (see Japanese Utility Model Registration Application No. 3116119).

### SUMMARY OF THE INVENTION

A massage system includes a medium and a massage machine. The medium includes data or an identification code. The massage machine includes a massage unit, a control unit, an input unit that captures the data or an identification code included in the medium, and an identification unit that identifies the data or the identification code. The control unit specifies a control content, based on an identification result obtained by the identification unit, and controls the massage unit according to the control content.

The data of a medium may include a bar code or two-dimensional codes. The control unit may store data of massage courses including different in massage operations. In this case the control content may correspond to one of the massage courses. The medium that includes the data or the identification code may be an electronic information communication terminal or a corporeal object such as a piece of paper, a plastic card, an IC card or another plastic card having a magnetic strip.

The control content may be determined according to the data or the identification code. The control content may be used to change a predetermined massage operation. The control content may be used to limit a number of identification times of the identification unit. The control content may be rewritable to a new control content of data or an identification code of a new medium. The data or the identification code may include parameters for the massage operations of the massage unit, and the control content may be used to set the parameters as the parameters of the control unit.

### BRIEF DESCRIPTION OF THE DRAWINGS

FIG. 1 is a side view of a massage machine according to an embodiment of the present invention.

FIG. 2 is a front view of a massage unit.

FIG. 3 is a block diagram of the massage machine.

FIGS. 4A and 4B are views describing a controller. FIG. 4A illustrates a state where data included in a medium is identified and displayed, and FIG. 4B illustrates a state where a identification code is identified.

FIGS. 5A and 5B are views illustrating media that include data or an identification code. FIG. 5A illustrates a state where the data or the identification code is displayed on a medium such as an electronic information communication terminal, and FIG. 5B illustrates a state where the data or the identification code is displayed on a corporeal object.

FIG. 6 is a flowchart for describing a series of operations in a massage course of the massage machine.

FIG. 7 is a flowchart in which a predetermined different massage course is operated for each user, based on an identification result.

FIG. 8 is a flowchart for describing an operation for selecting a predetermined massage course from a plurality of massage courses, depending on an age of a user.

FIG. 9 is a view in which parameters for massage operations of the massage unit which belong to a plurality sets of data or plurality sets of identification codes are included as parameters of a control unit.

FIG. 10 is an overall configuration diagram illustrating an information network system including the massage machine.

### EMBODIMENTS OF THE INVENTION

### Overall Configuration of Massage Machine

Hereinafter, an overall configuration of a massage machine 1 according to an embodiment of the present invention will be described.

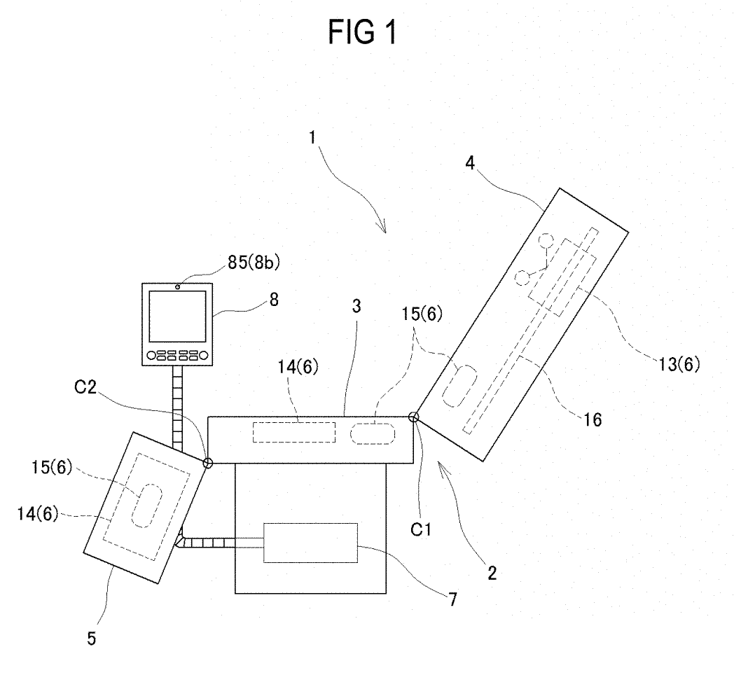

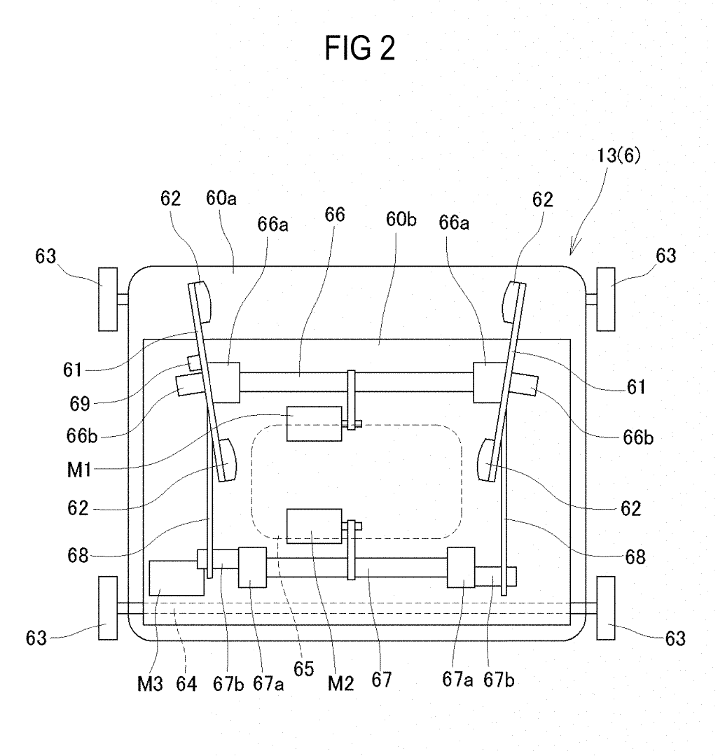

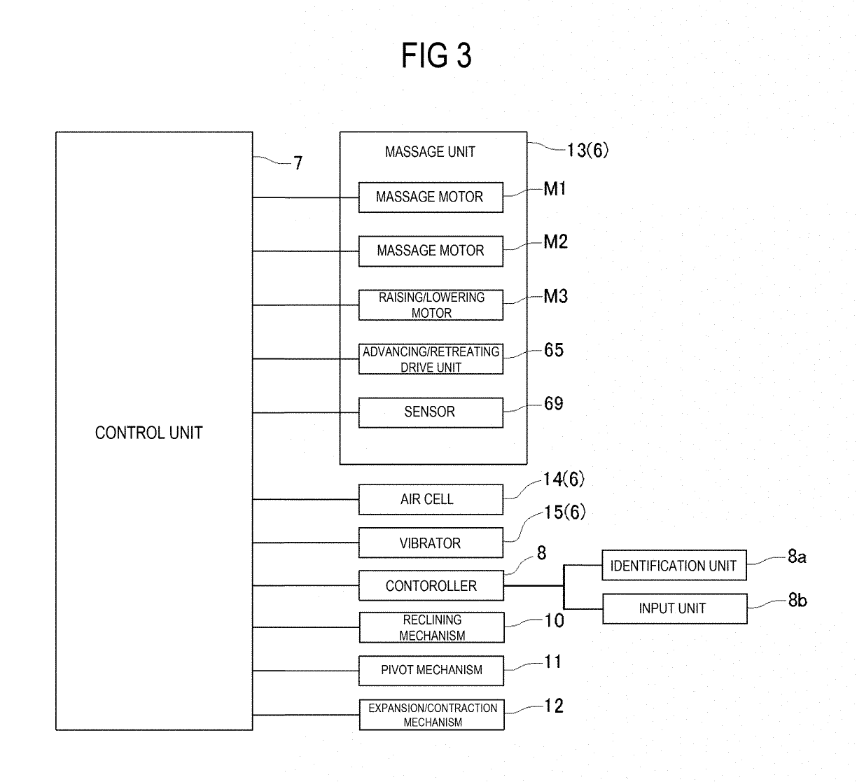

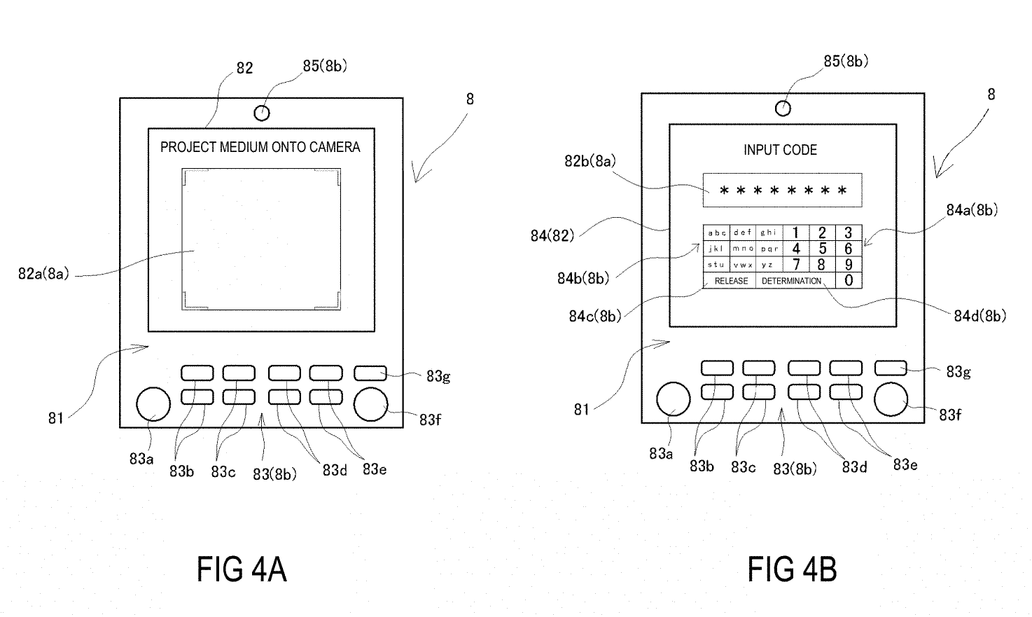

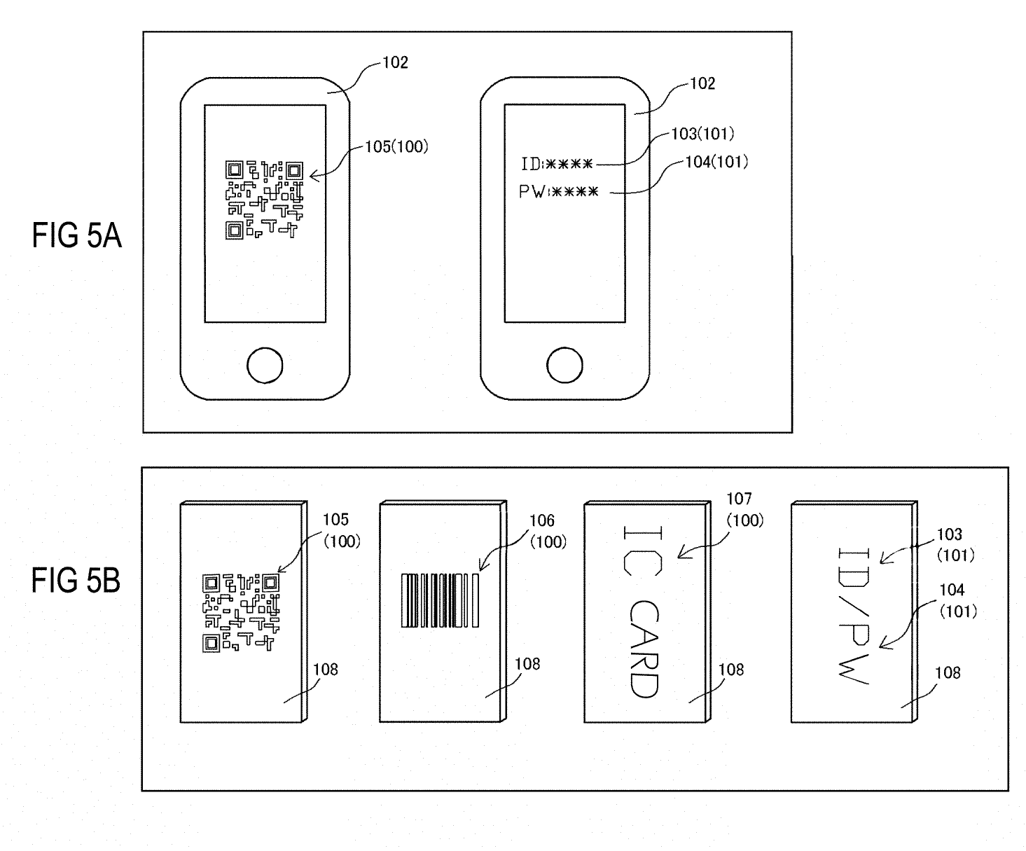

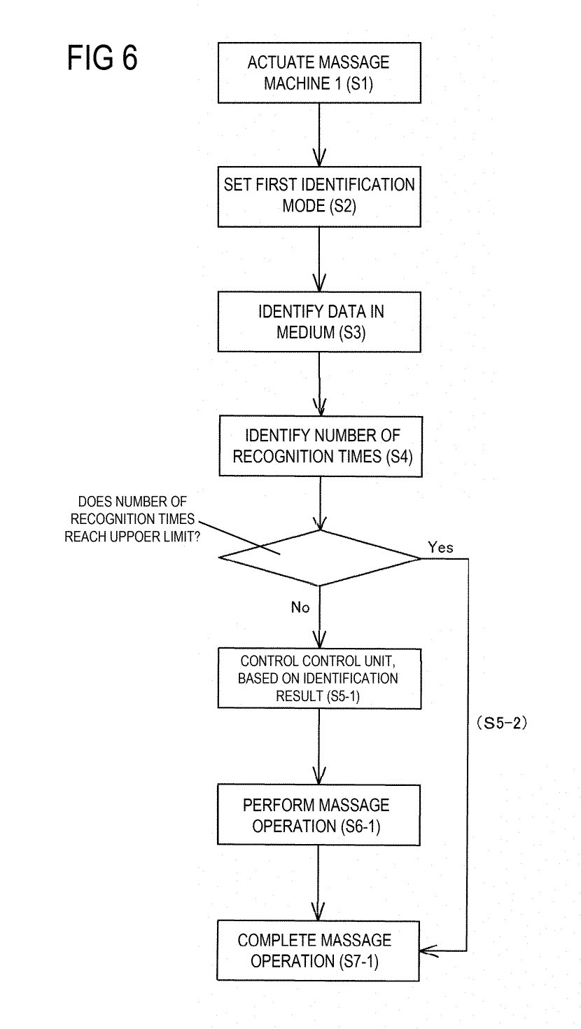

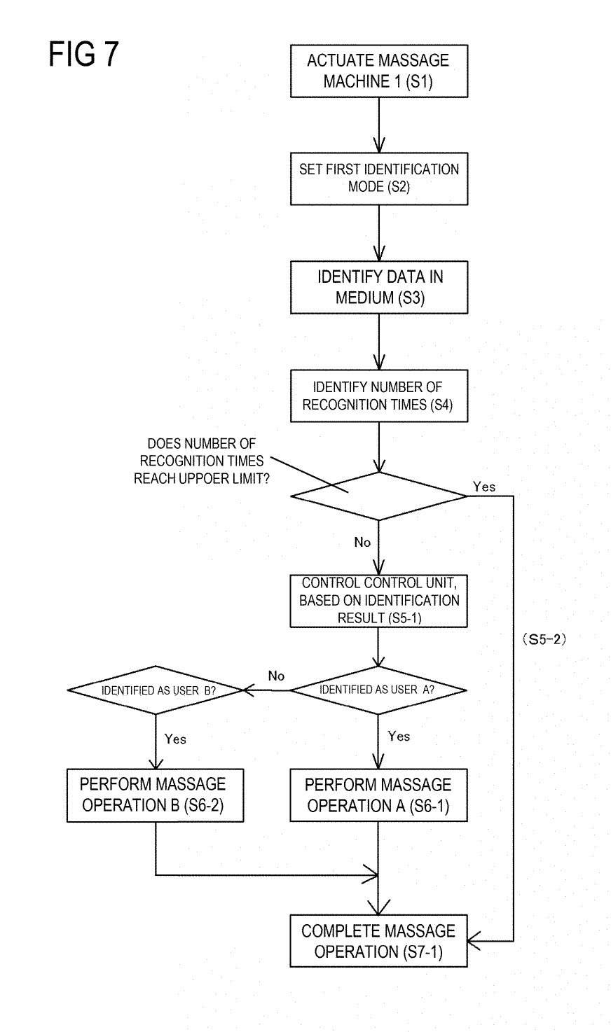

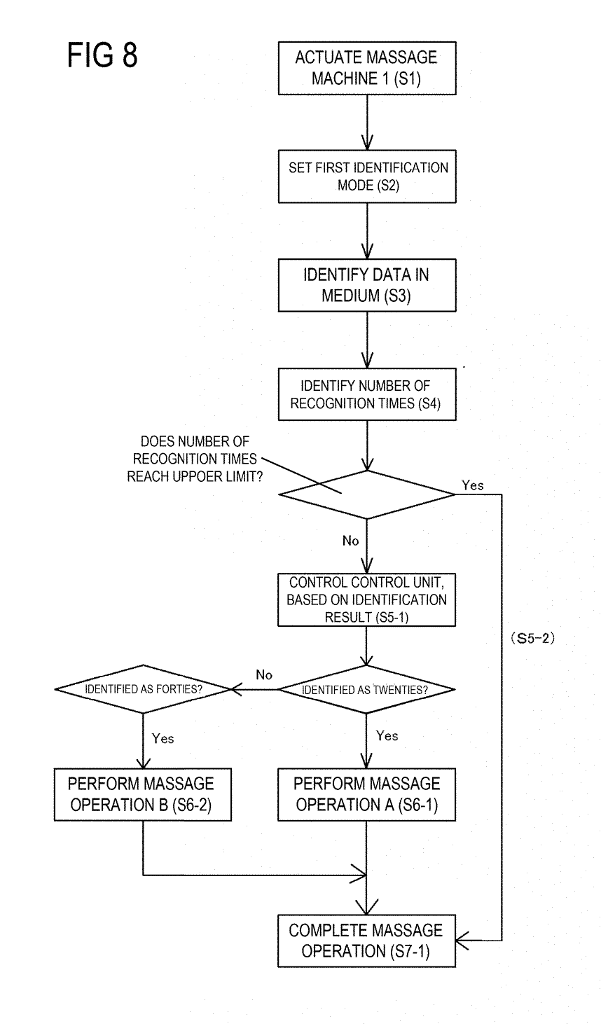

FIG. 1 is a side view of a massage machine 1 according to an embodiment of the present invention. FIG. 2 is a front view of a massage unit 13. FIG. 3 is a block diagram of the massage machine 1. FIGS. 4A and 4B are views for describing a controller 8. FIG. 4A illustrates a state where data 100 is identified and displayed, and FIG. 4B illustrates a state where a plurality of identification codes 101 is identified. FIGS. 5A and 5B are views illustrating the data 100 or the identification code 101. FIG. 5A illustrates a state where the data 100 or the identification code 101 is displayed on an electronic information communication terminal 102, and FIG. 5B illustrates a state where the data 100 or the identification code 101 are displayed on a corporeal object 108. FIG. 6 is a flowchart for describing a series of operations in a massage course of the massage machine 1. FIG. 7 is a flowchart in which a predetermined different massage course is operated for each user, based on an identification result. FIG. 8 is a flowchart for describing an operation for selecting a predetermined massage course from a plurality of massage courses, depending on an age of a user.

As illustrated in FIGS. 1 to 3, the massage machine 1 according to the embodiment of the present invention has a main body unit 2 configured to include a seat unit 3 on which a user sits, a backrest unit 4 which is disposed in a rear portion of the seat unit 3 and against which the user leans the back of the seat unit 3, and a foot rest 5 which is disposed in a front portion of the seat unit 3. In addition, the massage machine 1 has the massage unit 6 for massaging the user, a control unit 7 for controlling massage operations of the massage unit 6, and a controller 8 for performing various operations of the massage machine 1. A main body unit 2 may have each armrest disposed on both sides of the seat unit 3, and the massage unit 6 may be disposed in the armrest.

It is preferable that an operation of a reclining mechanism 10 having an actuator enables the backrest unit 4 to move (recline) in back and forth directions around a pivot shaft C1 which is disposed in the rear portion of the seat unit 3 and whose axial direction is right and left directions. It is preferable that an operation of a pivot mechanism 11 having an actuator enables the foot rest 5 to move (pivot) in up and down directions around a pivot shaft C2 which is disposed in the front portion of the seat unit 3 and whose axial direction is the right and left directions. It is preferable that an operation of an expansion/contraction mechanism 12 having an actuator enables the foot rest 5 to move (expand/contract) along a longitudinal direction of a lower leg.

The massage unit 6 has at least one of the massage unit 13 having a pair of right and left treatment devices 62 driven by motors M1 to M3, an air cell 14 which expands and contracts by supplying and discharging air, and a vibrator 15 driven by a motor. In the present embodiment, the massage unit 13 and the vibrator 15 are disposed in the backrest unit 4, and the air cell 14 and the vibrator 15 are disposed in the seat unit 3 and the foot rest 5. The arrangement of each massage unit 6 is not limited thereto. The air cell 14 can press a user by supplying and discharging the air. The vibrator 15 can give vibration to the user by rotating an eccentric weight.

### Configuration of Massage Unit

As illustrated in FIG. 2, the backrest unit 4 has the massage unit 13 for massaging an upper body of the user from behind (rear surface). This massage unit 13 is configured to include a pair of right and left arms 61 and the treatment devices 62 respectively disposed in upper and lower ends of the arm 61. In this manner, it is possible to perform kneading massage in which the right and left treatment devices 62 move close to and away from each other by driving a massage motor M1, and patting massage in which the right and left treatment devices 62 alternately advance toward and retreat from the user by driving a massage motor M2. In addition, the massage unit 13 can move upward or downward along a height direction of the user by driving a raising/lowering motor M3. In this manner, it is possible to change a position relative to the user's body, or to perform rolling massage. The backrest unit 4 has a pair of right and left guide rails 16 (refer to FIG. 1) extending in the height direction of the user, and the massage unit 13 moves along the guide rails 16. Since the massage unit 13 is movable in the height direction of the user, the treatment devices 62 can massage a site between the neck and the waist of the user.

As illustrated in FIG. 2, the massage unit 13 has a base frame 60a and a movable frame 60b supported by the base frame 60a. The base frame 60a has guide rollers 63 respectively fitted to the guide rails 16 on both right and left sides thereof. Then, the massage unit 13 can move along the height direction of the user by a raising/lowering mechanism (not illustrated) having a rack pinion. The movable frame 60b is supported by the base frame 60a via an oscillation shaft 64 in the right and left directions. An advancing/retreating drive unit 65 having an air cell is disposed between the base frame 60a and the movable frame 60b. Driving the advancing/retreating drive unit 65 enables the movable frame 60b to advance toward and retreat from the user around the oscillation shaft 64. A structure may be adopted in which the movable frame 60b does not advance toward and retreat from the user. Alternatively, a structure may be adopted in which the advancing/retreating drive unit 65 is disposed in the arm 61 so that only the arm 61 advances toward and retreats from the user.

The arm 61 is connected to a kneading shaft 66 and a patting shaft 67 which extend in the right and left directions. An inclined cam 66a having an inclined shaft 66b is disposed on both right and left sides of the kneading shaft 66. The arm 61 is attached to the inclined cam 66a. The inclined shafts 66b on the right and left are inclined with respect to an axis of the kneading shaft 66 so as to have a substantially inverted V-shape in a front view. An eccentric cam 67a having an eccentric shaft 67b eccentric to the axis of the patting shaft 67 is disposed on both right and left sides of the patting shaft 67. The arm 61 is connected to the eccentric cam 67a via a connecting rod 68. The eccentric shafts 67b on the right and left have mutually different phases with respect to the axis of the patting shaft 67. Specifically, the phases are different from each other by 180 degrees. The kneading shaft 66 and the patting shaft 67 are rotated by respectively driving the massage motors M1 and M2. The treatment device 62 performs kneading massage by rotating the kneading shaft 66, and performs patting massage by rotating the patting shaft 67. The arm 61 having the treatment device 62, the kneading shaft 66, and the patting shaft 67 are supported by the movable frame 60b. Accordingly, the treatment device 62 can advance toward and retreat from the user via the movement of the movable frame 60b.

The arm 61 is capable of oscillation in the back and forth directions, and is biased by biasing means (not illustrated) having a spring so that the treatment device 62 on the upper side projects forward. In addition, as illustrated in FIG. 3, the massage unit 13 has a sensor 69 for detecting physical information of the user. The sensor 69 can obtain the physical information by detecting whether the arm 61 reaches a predetermined oscillation position. Specifically, if the treatment device 62 on the upper side reaches above the shoulder of the user in a course of raising the massage unit 13 along the height direction of the user, load acting on the treatment device 62 is released. As a result of an operation of biasing means (not illustrated), the arm 61 oscillates forward so as to reach the predetermined oscillation position. The sensor 69 detects that the arm 61 reaches the predetermined oscillation position. At this time, a position of the shoulder is detected based on up and down positions of the massage unit 13. Based on the position of the shoulder, a position of other sites (neck, back, and waist) is obtained using calculation. The detected physical information is stored in a storage unit of the control unit 7. The physical information may be input by the user himself or herself. In this case, for example, the controller 8 can be operated so as to input the physical information. The physical information can be stored in the storage unit of the control unit 7.

### Configuration of Control System

As illustrated in FIG. 3, the massage machine 1 has the control unit 7 including a microcomputer for operating the massage unit 13, the air cell 14, the vibrator 15, the reclining mechanism 10, the pivot mechanism 11, the expansion/contraction mechanism 12, an identification unit 8a, and an input unit 8b. This control unit 7 is disposed under the seat unit 3, and is connected to the controller 8 operated by the user. The user operates the controller 8 so as to perform various massage operations. The control unit 7 has a storage unit that stores data of massage courses which are different in massage operations.

### Configuration of Controller

As illustrated in FIGS. 4A and 4B, the controller 8 has an operation unit 81 for performing various operations of the massage machine 1, a display unit 82 for displaying information relating to the massage machine 1, and a camera 85 serving as the input unit 8b that captures data 100 included in a medium 102 for identifying the data 100 (see FIG. 5A). The input unit 8b of the operation unit 81 according to the present embodiment is configured to include a physical button 83 operated by the user pushing with the fingertip of the user, and a touch panel 84 operated by the user with the fingertip of the user. The display unit 82 according to the present embodiment is configured to include the touch panel 84, and also functions as the operation unit 81. The display unit 82 may be disposed independently of the controller 8.

As the physical button 83, there are provided a “power button 83a” for actuating or stopping the massage machine by switching power supply states, a “position adjustment button 83b” for changing a position of the massage unit 13, a “reclining button 83c” for changing a posture of the backrest unit 4, a “pivot button 83d” for changing a posture of the foot rest 5, an “expansion/contraction button 83e” for changing a length of the foot rest 5, an “urgent stop button 83f” for urgently stopping all operations of the massage machine 1 during the operation, and an “identification mode button 83g” for proceeding to an identification mode for identifying data 100 or an identification code 101.

In addition, the display unit 82 of the controller 8 can display an “identification screen” for identifying the data 100. In a state where the “identification screen” displays the data 100, the user causes any data 100 to be projected onto the camera 85 serving as the input unit 8b disposed in an upper portion of the controller 8. In this manner, the massage machine 1 can be used by identifying the data 100.

In addition, in the touch panel 84, one or a plurality of operation keys are displayed on one screen serving as the identification unit 8a. It is preferable that the touch panel 84 includes one or a plurality of operation keys for operating the massage unit 6 in a second identification mode (to be described later). For example, the operation keys for operating the massage unit 6 include a “number selection key 84a”, an “alphabet selection key 84b” for inputting the identification code 101, a “delete key 84c” for deleting input content, or a “determination key 84d” for determining the input content. In the present embodiment, the physical button 83 and the touch panel 84 are combined to each other so as to configure the operation unit 81. However, the operation unit 81 corresponding to the respective buttons 83a to 83g and the respective operation keys 84a to 84d may be configured to include only the physical button 83 or only the touch panel 84.

### Identification Mode

If the “identification mode button 83g” disposed in the controller 8 is pressed, the display unit 82 proceeds to an identification mode for identifying the data 100 or the identification code 101. The “identification mode” has two identification modes such as a “first identification mode” for identifying the data 100 and a “second identification mode” for identifying the identification code 101.

Depending on the number of times at which the “identification mode button 83g” is pressed, the display unit 82 is sequentially switched to “the first identification mode→the second identification mode→identification mode completion”. In a case where the user performs identification using the data 100, the user presses the “identification mode button 83g” once, and in a case where the user performs identification using the identification code 101, the user presses the “identification mode button 83g” twice. In a case where the user completes the identification mode, the user presses the “identification mode button 83g” three times.

In this way, depending on the number of times at which the “identification mode button 83g” is pressed, the identification modes displayed on the display unit 82 are sequentially switched. Accordingly, even in a case where the user erroneously selects the number of times at which the “identification mode button 83g” is pressed, the identification mode desired by the user can be easily displayed on the display unit 82.

### First Identification Mode

The “first identification mode” which shows a state where the “identification mode button 83g” is pressed once as illustrated in FIG. 4A will be described.

The user presses the “power button 83a” so as to activate the massage machine 1. Then, the user presses the “identification mode button 83g” once so as to display the “first identification mode” on the display unit 82 of the controller 8. The “first identification mode” is a mode for identifying the data 100.

In the “first identification mode”, a first display screen 82a is displayed on the display unit 82. The first display screen 82a has a rectangular shape whose four corners are thickly emphasized in order to display the content projected onto the display unit 82 by the camera 85. The upper portion of the first display screen 82a displays a character such as “Project the data onto the camera”, and the user projects the data 100 onto the camera 85 so that the data 100 fits within the rectangular frame of the first display screen 82a, thereby identifying the data 100.

### Second Identification Mode

The “second identification mode” which shows a state where the “identification mode button 83g” is pressed twice as illustrated in FIG. 4B will be described.

The user presses the “power button 83a” so as to activate the massage machine 1. Thereafter, the user presses the “identification mode button 83g” twice so as to display the “second identification mode” on the display unit 82 of the controller 8. The “second identification mode” is a mode for identifying the identification code 101.

In the “second identification mode”, a character such as “Please input the identification code” is displayed in the upper portion of the display unit 82, and the second display screen 82b for displaying the content input by the input from the respective operation keys 84a to 84d is displayed in the lower portion of the display unit 82. The respective operation keys 84a to 84d displayed on the second display screen 82b are located on the touch panel 84.

The user identifies the identification code 101 by operating the respective operation keys 84a to 84d displayed on the second display screen 82b and by inputting an ID 103 or a password 104 serving as the identification code 101.

In the present embodiment, the data 100 is a QR code (Registered Trademark) 105. However, the data 100 may be a one-dimensional code such as a barcode 106, or a two-dimensional code or an IC card 107 other than the QR code (Registered Trademark) 105. In addition, the identification code 101 may be those other than the ID 103 or the password 104.

In addition, as shown in FIGS. 5A and 5B, the data 100 or the identification code 101 may be electronic data as displayed on a medium such as the electronic information communication terminal 102, or may be printed and displayed on a corporeal object 108 such as a piece of paper or a plate-shaped member.

### Configuration of Data or Identification Code

FIGS. 5A and 5B are views illustrating the data 100 or the plurality of identification code 101. FIG. 5A illustrates a state where the data 105 (100) or the identification code 103, 104 (101) is displayed on a medium such as an electronic information communication terminal 102. FIG. 5B illustrates a state where data 105, 106, 107 (100) or identification codes 103, 104 (101) are displayed on or stored in a medium of a corporeal object 108. As illustrated in FIGS. 5A and 5B, the data 100 is a data body that includes data concerning specific massage courses with which the service provider intends to provide the user, such as the two-dimensional code having the QR code (Registered Trademark) 105, the one-dimensional code having the barcode 106. The data 100 may be stored in an IC card 107. In addition, the data body may include personal information data of the user. The personal information is information which enables an individual user to be identified, such as a name, a sex, an age, a height, a weight, blood pressure, a pulse rate, the number of times at which the data 100 is used.

In addition, the identification code 101 may be a combination of alphabets, numbers, or symbols, which enables the individual user to be identified, such as the ID 103 and the password 104 that is stored in a medium 108 such as a piece of paper, a plastic card, a machine readable card such as an IC card or a card having a magnetic strip.

As illustrated in FIGS. 5A and 5B, the data 100 or the identification code 101 may be displayed on the electronic information communication terminal 102, or may be printed and displayed on the corporeal object 108 (plate-shaped member in FIGS. 5A and 5B), such as paper and plastic.

The data 100 or the identification code 101 is printed and displayed on electronic data as displayed on the medium such as an electronic information communication terminal 102 or a corporeal object 108 such as paper or plastic. Accordingly, the data of control content is easily rewritable to a new data of control content included in a new data 100 or a new identification code 101, thereby enabling the service provider to always reflect the newest personal information of the user.

The control content included in the data 100 or the identification code 101 includes data concerning a plurality of parameters for the massage operations of the massage unit (for example, in addition to the massage operations such as kneading and patting, parameters relating to the operation of the massage unit 6 such as the number of times, the speed, and the width). Therefore, the user can cause the identification unit 8a to identify the data 100 or the identification code 101. In this manner, the user can set the parameters as the parameters of the control unit 7.

In addition, the data 100 or the identification code 101 may have a “limitation function” to limit a function so that at least a portion of the previously stored control content cannot be used. In this case, it is possible to prevent the user from receiving a massage operation other than the massage operation intended by the service provider.

For example, a case will be described where when the service provider intends to provide a massage operation such as “kneading 1→patting 1→kneading 3”, the massage operation such as “kneading 1→patting 1→kneading 2→kneading 3” is stored in advance as the control content. Here, only the control related to the limitation function will be described.

The control content such as “kneading 1→patting 1→kneading 3” which is the massage operation intended by the service provider is stored in the QR code (Registered Trademark) 105 serving as the data 100. The user projects the QR code (Registered Trademark) 105 serving as the data 100 onto the camera 85 disposed in the upper portion of the controller 8, and identifies the data 100. The control content (“kneading 1→patting 1→kneading 2→kneading 3”) stored in the control unit 7 and the control content (“kneading 1→patting 1→Kneading 3”) stored in the QR code (Registered Trademark) 105 are compared with each other. In this manner, the control for excluding a limitation target massage operation (“kneading 2”) from the previously stored control content is performed so as to match the control content (“kneading 1→patting 1→Kneading 3”) stored in the QR code (Registered Trademark) 105.

A target of the limitation function may be a limitation on selectable courses, a limitation on reclining angles, and a limitation on angles of the foot rest.

FIG. 6 is a flowchart for describing a series of operations of the massage course of the massage machine 1. In the present embodiment, a case will be described where the QR code (Registered Trademark) 105 serving as the data 100 is identified.

The service provider who manages facilities used by unspecified people, such as hairdressers and car dealers, first gives the user the data 100 storing the massage operations which the service provider wants the user to receive. The data 100 is given to the user, thereby enabling the user to use the massage machine and other health appliances by using the data 100.

The data 100 is provided for the user, thereby enabling the user to receive the massage while the service provider serves other guests in the hairdressers and car dealers. Therefore, the user can enjoy a relaxation effect.

As illustrated in FIG. 6, the user first presses the “power button 83a” of the massage machine 1, and actuates the massage machine 1 (S1). If the massage machine 1 is actuated, a character such as “Please select any desired identification mode with the identification mode button” is displayed on the display unit 82 of the controller 8. While the character such as “Please select any desired identification mode with the identification mode button” is displayed, the operation using other operation buttons is invalid. Thereafter, the user presses the “identification mode button 83g” once so as to set the “first identification mode” (S2). Then, the user confirms that the display unit 82 of the controller 8 shows the first display screen 82a, and the user identifies the data 100 by projecting the QR code (Registered Trademark) 105 serving as the data 100 onto the camera 85 disposed in the upper portion of the controller 8 (S3). The massage machine 1 identifies the number of times at which the QR code (Registered Trademark) 105 (the number of recognition times) from the information of the QR code (Registered Trademark) 105 projected onto the camera 85 (S4). As the identified result, in a case where the number of times at which the QR code (Registered Trademark) 105 (the number of recognition times) reaches the upper limit number stored in the QR code (Registered Trademark) 105, the operation of the massage machine 1 is completed (S5-2). As the identified result, in a case where the number of times at which the QR code (Registered Trademark) 105 (the number of recognition times) does not reach the upper limit number stored in the QR code (Registered Trademark) 105, the control unit 7 is controlled based on the information stored in the QR code (Registered Trademark) 105 (S5-1), and the massage operation of the massage machine 1 is performed (S6-1). Thereafter, the massage operation is completed (S7-1).

FIG. 7 is a flowchart in which a predetermined different massage course is operated for each user, based on the identification result. In the present embodiment, a case will be described where the data 100 is identified. As illustrated in FIG. 7, the user first presses the “power button 83a” of the massage machine 1 so as to actuate the massage machine 1 (S1). Thereafter, the user presses the “identification mode button 83g” once so as to set the first identification mode (S2). Then, the user confirms that the display unit 82 of the controller 8 shows the first display screen 82a, and the user identifies the data 100 by projecting the QR code (Registered Trademark) 105 serving as the data 100 onto the camera 85 disposed in the upper portion of the controller 8 (S3). The massage machine 1 identifies the number of times at which the QR code (Registered Trademark) 105 is used (the number of recognition times) from the information of the QR code (Registered Trademark) 105 projected onto the camera 85 (S4). As the identified result, in a case where the number of times at which the QR code (Registered Trademark) 105 is used (the number of recognition times) reaches the upper limit number stored in the QR code (Registered Trademark) 105, the operation of the massage machine 1 is completed (S5-2). As the identified result, in a case where the number of times at which the QR code (Registered Trademark) 105 is used (the number of recognition times) does not reach the upper limit number stored in the QR code (Registered Trademark) 105, the control unit 7 is controlled based on the information stored in the QR code (Registered Trademark) 105 (S5-1), and the massage operation of the massage machine 1 is performed (S6-1 and S6-2). Thereafter, the massage operation is completed (S7-1).

As a result of identifying the QR code (Registered Trademark) 105, in a case where it is identified as a user A, a massage course A corresponding to the user A is selected from a plurality of massage courses, and a massage operation A is performed by the control unit 7 which controls the operation of the massage unit (S6-1). In addition, as a result of identifying the QR code (Registered Trademark) 105, in a case where it is identified as a user B, a massage course B corresponding to the user B is selected from the plurality of massage courses, and a massage operation B is performed by the control unit 7 which controls the operation of the massage unit (S6-2). In this way, the user can be determined by identifying the QR code (Registered Trademark) 105. Accordingly, even if a plurality of users use the same massage machine 1, the user can receive the massage course suitable for the user. Therefore, the service provider enables a specific user to receive a specific massage course.

FIG. 8 is a flowchart for describing the operation of selecting a predetermined massage course depending on an age of the user from the plurality of the massage courses. In the present embodiment, a case will be described where the different data 100 included in a medium is given to the user depending on the age of the user. As illustrated in FIG. 8, the user first presses the “power button 83a” of the massage machine 1 so as to actuate the massage machine 1 (S1). Thereafter, the user presses the “identification mode button 83g” once so as to set the first identification mode (S2). Then, the user confirms that the display unit 82 of the controller 8 shows the first display screen 82a, and the user the user identifies the data 100 by projecting the QR code (Registered Trademark) 105 serving as the data 100 onto the camera 85 disposed in the upper portion of the controller 8 (S3). The massage machine 1 identifies the number of times at which the QR code (Registered Trademark) 105 is used (the number of recognition times) from the information of the QR code (Registered Trademark) 105 projected onto the camera 85 (S4). As the identified result, in a case where the number of times at which the QR code (Registered Trademark) 105 is used (the number of recognition times) reaches the upper limit number stored in the QR code (Registered Trademark) 105, the operation of the massage machine 1 is completed (S5-2). As the identified result, in a case where the number of times at which the QR code (Registered Trademark) 105 is used (the number of recognition times) does not reach the upper limit number stored in the QR code (Registered Trademark) 105, the control unit 7 is controlled based on the information stored in the QR code (Registered Trademark) 105 (S5-1), and the massage operation of the massage machine 1 is performed (S6-1 and S6-2). Thereafter, the massage operation is completed (S7-1).

As a result of identifying the QR code 105 (Registered Trademark), in a case where it is identified as the user A (twenties), the massage operation A is performed by the control unit 7 which controls the operation of the massage unit (S6-1). As a result of identifying the QR code (Registered Trademark) 105, in a case where it is identified as the user A (forties), the massage operation B is performed by the control unit 7 which controls the operation of the massage unit (S6-2). Thereafter, the massage operation is completed (S7-1).

In this way, the user can receive the massage course by identifying the QR code (Registered Trademark) 105, even if the same user has different ages. Therefore, the service provider enables the user to receive a specific massage course.

It is also possible to change at least some of the predetermined massage operations in the plurality of massage operations. In the present embodiment, a case will be described where the data 100 is identified. For example, a case will be described where the identification result of the user A is the “massage course A” and the operation content of the “massage course A” is “rolling→kneading→patting→kneading”.

The personal information of the user A is stored in the QR code (Registered Trademark) 105 serving as the data 100. The user A can receive the massage operation by causing the identification unit 8a to identify the QR code (Registered Trademark) 105. In a case where it is determined that the user A is recommended to receive the massage operation for lowering blood pressure, based on the information such as the personal information (for example, blood pressure) of the user A, it is possible to change some of the predetermined massage operations of the massage course so as to be “rolling→patting→kneading→patting”.

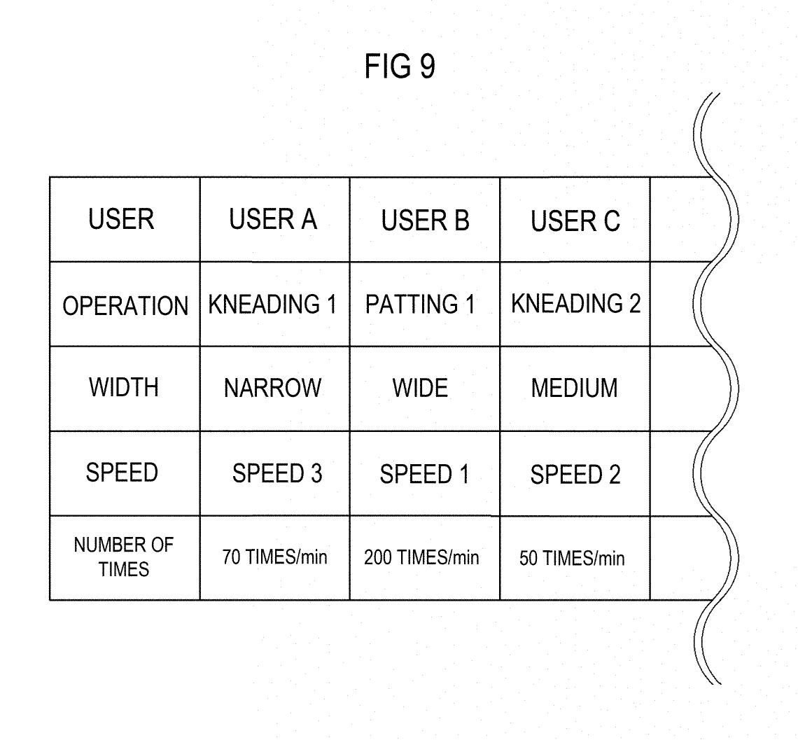

FIG. 9 is a view in which a plurality of parameters for the massage operations of the massage unit which belong to the plurality sets of data 100 or the plurality sets of identification codes 101 are included as parameters of the control unit 7. As illustrated in FIG. 9, the plurality of parameters including the massage operation, the width, the speed, and the number of times are stored in the plurality sets of data 100.

For example, the parameters for the massage operations such as “the massage operation (kneading 1), the width (narrow), the speed (speed 3), the number of times (70 times/min)” are stored in the data 100 belonging to the user A. When the user A uses the massage machine 1, the user A can set the parameters as the parameter of the control unit 7 by first causing the identification unit 8a to identify the data 100 belonging to the user A.

In addition, the parameters for the massage operations such as “the massage operation (patting 1), the width (wide), the speed (speed 1), the number of times (200 times/min)” are stored in the data 100 belonging to the user B. When the user B uses the massage machine 1, the user B can set the parameters as the parameter of the control unit 7 by first causing the identification unit 8a to identify the data 100 belonging to the user B.

In addition, the parameters for the massage operations such as “the massage operation (kneading 2), the width (medium), the speed (speed 2), the number of times (50 times/min)” are included in the data 100 belonging to the user C. When the user C uses the massage machine 1, the user C can set the parameters as the parameter of the control unit 7 by first causing the identification unit 8a to identify the data 100 belonging to the user C.

In this way, the parameters for the massage operations can be set for each user. Therefore, the service provider enables the user to receive an effective massage course suitable for the user.

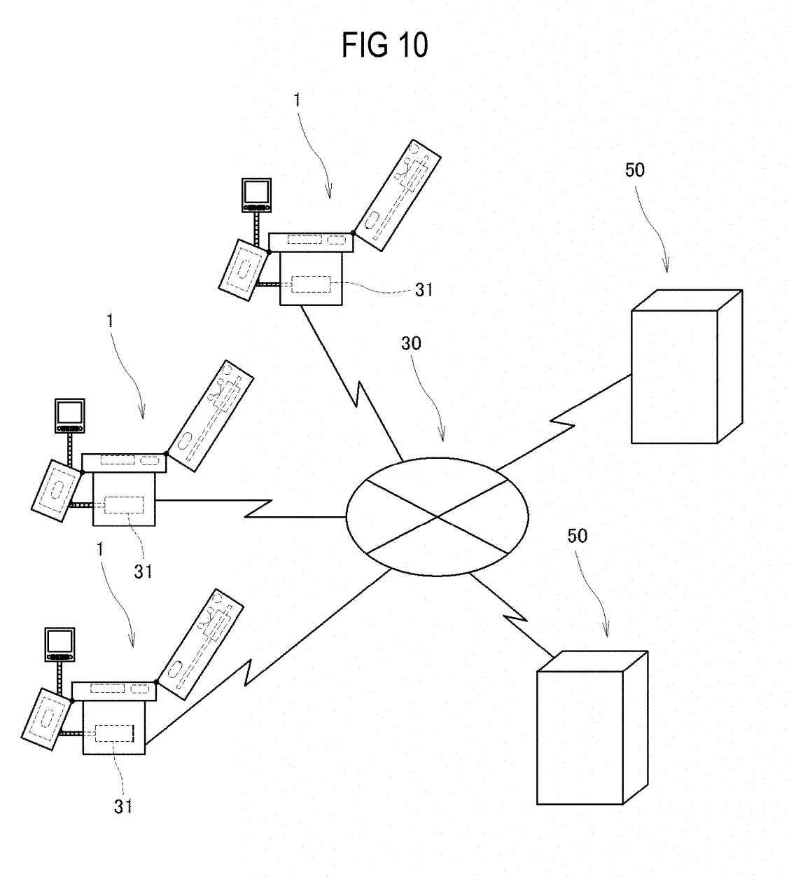

In addition, the massage machine 1 according to the present invention is not limited to the illustrated form, and may employ another form within the scope of the present invention. FIG. 10 is an overall configuration diagram illustrating an information network system including the massage machine 1.

For example, as illustrated in FIG. 10, the massage machine 1 may have communication means 31 for receiving information from the outside, and a communication server 50. The communication server 50 is configured to be capable of communicating with the massage machine 1 via the communication network 30. For example, the communication network 30 includes the Internet network, a communication network in a building, and a network in a local area. In the present embodiment, the communication server 50 is configured to employ a cloud type. A large number of personal information items which are not included in the QR code (Registered Trademark) 105 for each user are accumulated in the communication server 50.

If the identification unit 8a identifies the data 100 or the identification code 101, the identification result is transmitted to the communication server 50. Based on the transmitted identification result, the communication server 50 determines the user matching the identification result from the personal information accumulated in the communication server 50. Thereafter, the massage operation corresponding to the user is transmitted to the massage machine 1 via the communication network 30.

According to this configuration, even in a case where the massage machine 1 is used at a remote place, the user can receive a massage course suitable for the user.

In addition, the massage machine 1 may be able to conversate with the user. In this case, it is preferable to provide voice recognition means for recognizing a voice output from the user, and it is preferable that an artificial intelligence technology is included in the control unit 7. According to this configuration, it is possible to conversate with the user via the display unit 82 of the controller 8 or a voice output unit (not illustrated). Therefore, the information relating to the massage machine 1 can be more properly given to the user.

In addition, instead of the data 100 or the identification code 101, a configuration may be adopted so as to identify the face of the user. For example, the user presses the “identification mode button 83g” so as to proceed to a “third the identification mode”. The “third identification mode” is a mode for identifying the face of the user instead of the data 100 or the identification code 101. Thereafter, the user projects the user's own face onto the camera 85 serving as the identification unit 8a. The identification unit 8a identifies the face (eye, nose, mouth position) of the user projected onto the camera. Based on the identification result, the control unit 7 performs the massage operation intended by the service provider, which is suitable for the user. It is also possible to identify the age of the user from the eye, the nose, or the mouth position of the user projected onto the camera.

In this way, the user does not need to separately carry the data 100 or the identification code 101. Accordingly, even if the user forgets to carry the data 100 or the identification code 101, the user can use the massage machine 1.

Although the invention is described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. Moreover, no element or component in this disclosure is intended to be dedicated to the public regardless of whether the element or component is explicitly recited in the following claims.

What is claimed is:

1. A massage system comprising:
a medium and a massage machine; wherein
the medium includes data or an identification code;
the massage machine includes:
a massage unit;
a control unit;
an input unit that captures the data or the identification code; and
an identification unit that identifies the data or the identification code,
wherein the control unit specifies a control content, based on an identification result obtained by the identification unit, and controls the massage unit according to the control content.

2. A massage system according to claim 1, wherein:
the data includes a bar code.

3. The massage system according to claim 1,
wherein the data includes two-dimensional codes.

4. The massage system according to claim 1,
wherein the control unit stores data of massage courses including different in massage operations, and
wherein the control content corresponds to one of the massage courses.

5. The massage system according to claim 1,
wherein the control content is used to change a predetermined massage operation.

6. The massage system according to claim 1,
wherein the control content is used to limit a number of identification times of the identification unit.

7. The massage system according to claim 1,
wherein the control content is rewritable to a new control content based on new data or a new identification code included in a new medium.

8. The massage system according to claim 1,
wherein the data or the identification code includes parameters for the massage operations of the massage unit, and
wherein the control content is used to set the parameters as the parameters of the control unit.

9. A massage machine comprising:
a massage unit;
a control unit;
an input unit that captures data or an identification code; and
an identification unit that identifies the data or the identification code,
wherein the control unit specifies a control content, based on an identification result obtained by the identification unit, and controls the massage unit according to the control content.

10. A massage machine according to claim 9, wherein:
the data includes a bar code.

11. The massage machine according to claim 9,
wherein the data includes two-dimensional codes.

12. The massage machine according to claim 9,
wherein the control unit stores data of massage courses including different in massage operations, and
wherein the control content corresponds to one of the massage courses.

13. The massage machine according to claim 9,
wherein the control content is used to change a predetermined massage operation.

14. The massage machine according to claim 9,
wherein the control content is used to limit a number of identification times of the identification unit.

15. The massage machine according to claim 9,
wherein the control content is rewritable to a new control content based on new data or a new identification code.

16. The massage machine according to claim 9,
wherein the data or the identification code includes parameters for the massage operations of the massage unit, and
wherein the control content is used to set the parameters as the parameters of the control unit.
